(19) United States
(12) Patent Application Publication
(10) Pub. No.: US 2014/0156504 A1
(43) Pub. Date: Jun. 5, 2014

(54) COLLEGE LOAN FINANCIAL SYSTEM AND METHOD

(71) Applicant: Steven MUSZYNSKI, Lyndhurst, OH (US)

(72) Inventor: Steven MUSZYNSKI, Lyndhurst, OH (US)

(21) Appl. No.: 14/063,296

(22) Filed: Oct. 25, 2013

Related U.S. Application Data
(60) Provisional application No. 61/718,929, filed on Oct. 26, 2012.
(60) Provisional application No. 61/823,079, filed on May 14, 2013.

(51) Int. Cl. G06Q 40/02

(52) U.S. Cl. CPC G06Q 40/025
USPC 705/38

(57) ABSTRACT

A method of determining default risk without use of credit score and providing discounted loans includes, receiving from a customer payments put into an account of the customer of a predetermined amount paid periodically over a predetermined time frame, determining default risk based on such received amounts, determining whether the customer qualifies for a discounted loan rate, and providing the customer such loan at discounted rate if the customer qualifies. Apparatus for carrying out one or more of the foregoing steps.

### CROSS REFERENCE TO RELATED APPLICATIONS

Priority is claimed from U.S. provisional patent applications No. 61/718,929, filed Oct. 26, 2012 and No. 61/823,079, filed May 14, 2013, the entire disclosures of which hereby are incorporated by reference.

### TECHNICAL FIELD

The present invention relates generally, as indicated, to a college savings and loan financial system and method, and, more particularly, to obtaining loan financing of the college education costs.

### BACKGROUND

There are over 20 million undergraduate students attending college in the United States. In 2011, parents were the largest source of college funding, covering 37% of total college expenses on average, through both the use of loans and savings. As the cost of education rises, more and more families need to take out loans to pay for their child's education. Families used loans to cover 27% of college costs during the 2011 academic year, which is up from 22% the year before. The government is the largest player in this industry accounting for 93% of all student loans. There are several types of loans currently available in the marketplace, each carrying a different interest rate. Subsidized and Unsubsidized Stafford loans carry interest rates the 10-Year Treasury note +2.05%. The only difference between a Subsidized Stafford and an Unsubsidized Stafford loan is whether the government pays the student's interest payments while the student is in school. Stafford loans have a lifetime maximum of $31,000. With the average cost of a four year education well above that figure, many parents need to seek additional financing options.

Currently, 900,000 households use a specific type of loan each year called a Parent PLUS Loan. These loans have a fixed interest rate of the 10-Year Treasury note+4.6% and are used to cover the gap between savings, scholarships, grants, other loans, and the cost of college. The problem with this program is that all borrowers are charged the same interest rate regardless of their risk profile. Over 200,000 borrowers have projected default rates of 31%, but they are charged the same interest rate as the 1 million borrowers who have projected default rates of 2%. Therefore, many people who have a low default risk are subsidizing the defaults of others. Some parents are charged an interest rate that is too high, while others are charged a rate that is too low.

### SUMMARY

A method of determining default risk without use of credit score, includes,
a. Receiving from a customer deposits put into an account of the customer of a predetermined amount paid periodically over a predetermined time frame,
c. Offering to the customer a loan to provide funds to the customer in a loan amount that is no greater than the approved Parent PLUS borrowing maximum as determined by individual universities through the formula of the total cost of college minus received federal aid with interest computed at a prescribed amount less than the interest rate for a Parent Plus loan, and repayment of the still owed loan amount plus interest being due and payable to the company at a rate at least equal to the predetermined amount specified in step a,
d. At the conclusion of the predetermined time frame, returning the deposits to the customer, and
e. If the customer accepts the loan offered at step c, also providing the customer the requested loan amount in step c.

A method of determining default risk without use of credit score and providing discounted loans includes, receiving from a customer deposits put into an account of the customer of a predetermined amount paid periodically over a predetermined time frame, determining default risk based on such received amounts, determining whether the customer qualifies for a discounted loan rate, and providing the customer such loan at discounted rate if the customer qualifies. Apparatus for carrying out one or more of the foregoing steps.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a block diagram schematically illustrating an embodiment of the invention;

FIG. 2 is a logic diagram or flow chart illustrating an embodiment of the invention from the perspective of a customer;

FIG. 3 is a logic diagram or flow chart illustrating an embodiment of the invention from the perspective of a bank or other financial institution;

FIG. 4 is a schematic illustration of an exemplary computer hardware system for use in carrying out respective embodiments of the invention; and

FIG. 5 is a schematic operational flow chart representing an example of carrying out the invention.

### DESCRIPTION

It is the above-described issue presented in the background that the embodiments of the invention described below address. Such sometimes is referred to as the LENDULINK™ product.

The system and method of this disclosure, which also is referred to below as “product” offers consumers the ability receive a future educational loan at a 150 bps (basis points) discount or other determined discount, to the current Parent Plus rate of the 10-Year Treasury Note+4.6%, for example. The risk management idea behind this product is that people who have proven their ability to repay a future loan should be given an interest rate to reflect that reduced risk.

Thus, as is illustrated in FIG. 1, a system and method 10 is summarized. At step (or block) 11 a customer is given an opportunity to prove the ability to repay a future loan. At step 12 a loan is given to the customer at a discounted interest rate since the aforementioned proof had been given and, therefore, the risk of the customer not fully repaying the loan is reduced relative to non-proven customers.

Customers contribute, e.g., pay or deposit, into a newly created college savings account which receives the normal savings rate. This deposit when made monthly for at least two years and at a minimum of $300 (or at some other time period that is more or less than two years and at a minimum of more or less than the $300 amount), without withdrawals, enacts a contract guaranteeing the customer a future college loan at a 150 bps discount to the Parent Plus interest rate at the time of a loan. Although the Parent PLUS interest rate is the standard interest rate used for examples herein, it will be appreciated that a different interest rate or interest rate program may be used.

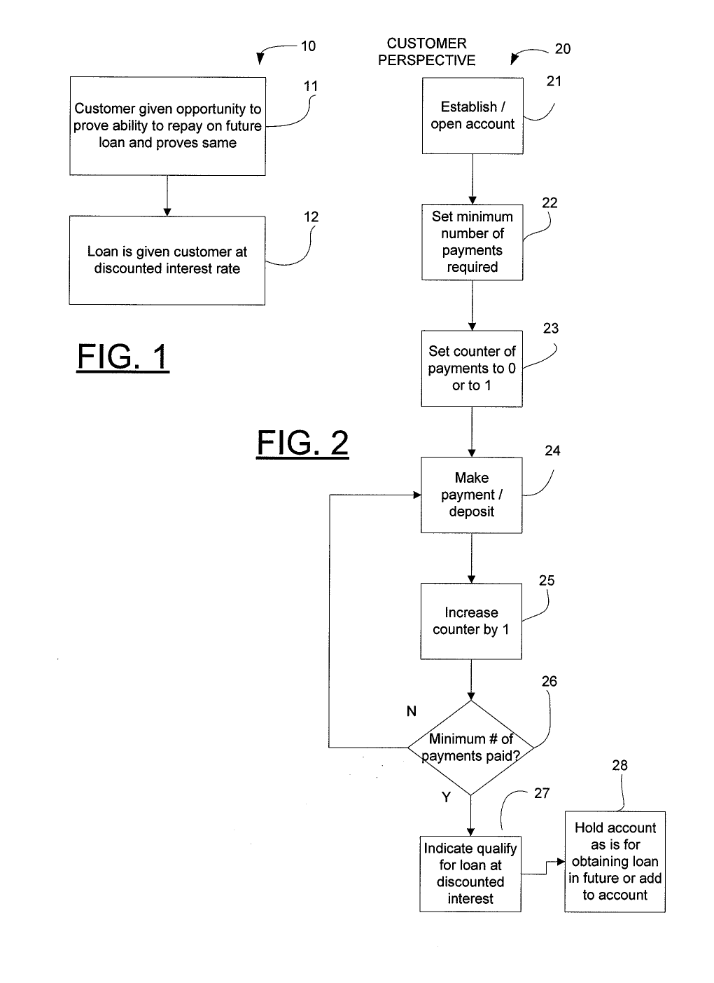

Referring to FIG. 2, a logic diagram or computer program flow chart 20 is illustrated showing from the point of view of a customer an embodiment of the invention. At step 21 a customer establishes (e.g., opens) an account with a bank; usually this would entail making the first deposit required according to the invention. The account may be a savings account or some other type account according to the invention (collectively referred to below as savings account). At step 22 a minimum number of payments value is set. This would be the minimum number of payments or deposits that are required to be made to the savings account according to the invention to qualify for the discounted loan described herein. For example, the customer may enter a number in a recurring deposit schedule or automatic deposit to be made from the customer's checking account at a bank, such that the recurring deposit occurs a prescribed number of times at monthly intervals for a prescribed amount to be made to the savings account at a savings institution or other facility that is associated with the Lendulink system of the invention. Alternatively, the customer may note that he/she must make the deposit periodically into the specified savings account, e.g., monthly.

In the logic diagram 20 at step 23 a counter of the number of deposits made is set to a value to represent the number of required deposits already made to the account. If the account was established with the making of the first required deposit (note, reference to payment herein means a payment made as a deposit to the savings account, e.g., by the customer,—the terms payment and deposit may be used interchangeably and equivalently herein), then the counter is set to a value one; if no payment was made when the account was established, then the value of the counter is set to zero.

At step 24 the customer makes a payment.

At step 25 a value of one is added to the counter, e.g., the counter that was set at step 23, to reflect that the next payment was made. At step 26 an inquiry is made whether the value of the counter (from step 25) and the value of the minimum number of payments (from step 22) are equal. If no, then the logic diagram returns to step 24 to await the next payment. If yes, then at step 27 an indication is given or a flag is set, and so on, to indicate that the customer now qualifies for the discounted loan. This indication may be provided to the bank, savings institution, proprietor of the Lendulink system, and so on, so that the customer may obtain the discounted loan when needed. This indication reflects that the customer is likely to be one who would appropriately repay the loan and would not default on the loan. At step 28 the customer may hold the savings account as is until needing the loan or may add to the savings account.

Alternatively, as another example, customers may deposit a minimum of $500 for 12 consecutive months and receive the same benefits as if they had entered the 24 month program. The deposits act as both a forced savings account for parents and as an “investment”, since a return can be calculated from the savings. A 30 day grace period will be allowed for customers to make their deposits without forfeiting their ability to receive a discounted loan. Also, withdrawals from the savings account are permitted, but any withdrawal amount that causes the monthly deposit total to fall below $300 results in a customer losing their future program loan eligibility. As an example, if a customer deposited $500 in one month, the customer would be able to withdraw $200 at any time without penalty. However, if more than $200 is withdrawn without be re-deposited within 30 days, then the customer loses access to a future discounted loan. The same logic will be used for the 12 month program and a minimum $500 monthly deposit balance. After two years of consistent deposits, the customer qualifies for the promised loan at the fixed rate of the 10-year Treasury note+3.1%. At the time of the loan, the customer can receive back the savings along with the accumulated interest on the contributions. This accumulated interest compounds monthly over the investment period. Customers can borrow up to the maximum

Parent PLUS loan eligibility, as determined by individual universities through the formula of the cost of college minus federal aid, and the loans shall bedistributed directly to the university but in any amount suitable to the customer. Customers must have a minimum 650 credit score to enter the savings program and they must also have a minimum 650 credit score to receive a loan. However, as long as a customer meets the savings and credit score requirements over either 12 or 24 months depending on the customer's chosen program, the customer is eligible for the discounted loan. All eligible customers receive the same interest rate regardless of their credit score; as such this program does use credit score to determine a customer's risk level

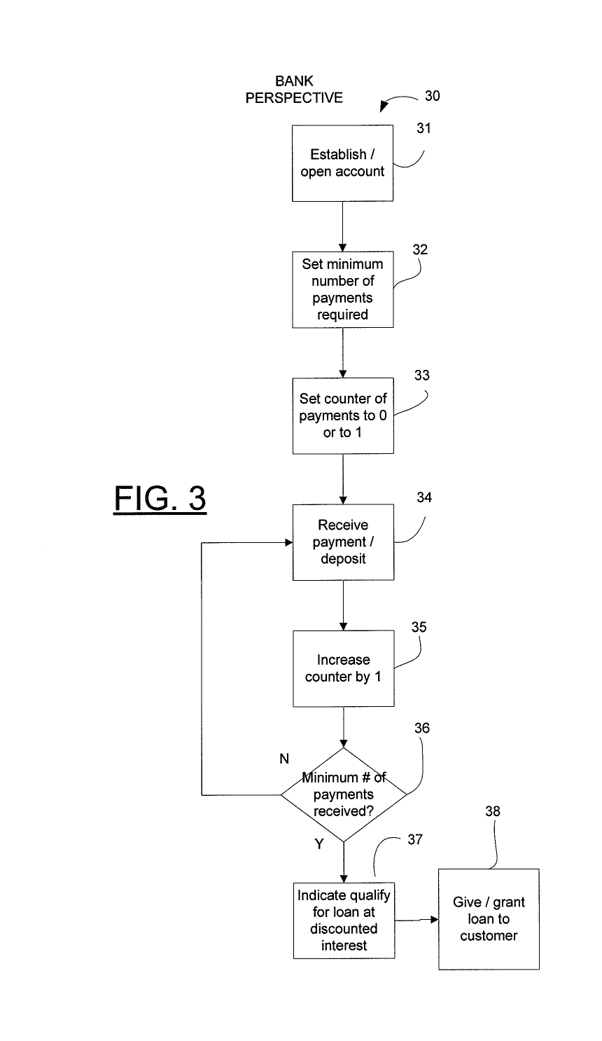

Referring to FIG. 3, an embodiment of a method according to the invention from the perspective of a bank, savings institution, etc., is illustrated at the logic diagram or flow chart 30. At step 31 the aforementioned savings account of the customer is opened. At step 32 a minimum number of payments value is set, which corresponds to the value set at step 22 in the logic diagram 20 of FIG. 2. At step 33 a counter is set to a value reflecting the number of payments (deposits) made by the customer—either zero or one, depending on whether an initial payment was made when the account was opened, as was described above at step 23 in FIG. 2. At step 34 a payment (deposit) is received and is credited to the savings account of the customer. At step 35 the counter value is incremented by one. At step 36 an inquiry is made whether the counter value equals the minimum number of required payments (deposits). If not yet equal, then the logic diagram returns to step 34 to await the next payment. If at step 36 the minimum number of required payments value and the counter are equal, then at step 37 an indication is given that the customer qualifies for the discounted loan, as is described above.

The money that is deposited in the savings account receives interest in the usual manner of a typical savings account, for example, of the bank. The value of the savings account thus would increase both as payments are made by the customer and as interest is accumulated thereby to provide more money towards paying for the customer's education requirements.

At step 38, then, since the customer qualifies for the discounted loan, the bank or other institution providing loans described herein, may offer a customer a loan at the discounted interest rate.

Summarizing an embodiment of the methods described herein:

A method of determining default risk without use of credit score is provided. The method includes, for example, the steps of,
a. Receiving from a customer payments put into an account of the customer of a predetermined amount paid periodically over a predetermined time frame,
c. Offering to the customer a loan to provide funds to the customer in a loan amount that is no greater than the approved Parent PLUS borrowing maximum as determined by individual universities through the formula of the total cost of college minus received federal aid with interest computed at a prescribed amount less than the interest rate for a Parent Plus loan, and repayment of the still owed loan amount plus interest being due and payable to the company at a rate at least equal to the predetermined amount specified in step a,
d. At the conclusion of the predetermined time frame, returning the payments to the customer, and
e. If the customer accepts the loan offered at step c, also providing the customer the requested loan amount in step c.

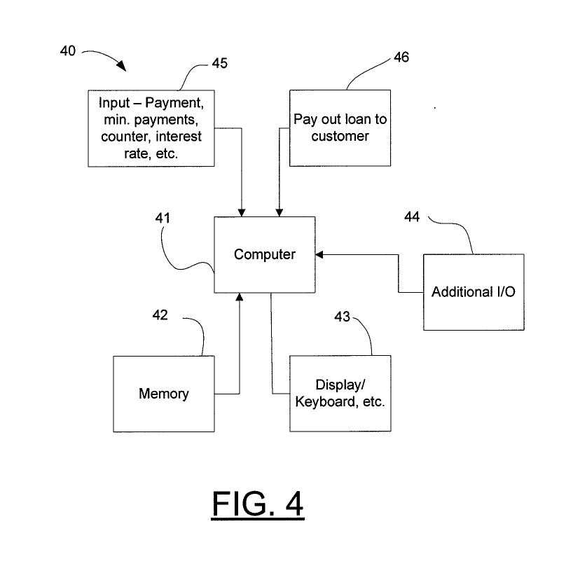

Turning now to FIG. 4, an example of a computer hardware system 40 for use by a bank, for example, in carrying out this invention is illustrated. Alternatively, the computer hardware system 40 may be used by an administrator entity that monitors customers' opening of savings accounts, payments (deposits) made to the accounts, qualifying by customers for discounted loans, and so on as disclosed herein.

The computer hardware system 40 includes a computer 41, e.g., a personal computer, server, main frame computer or any other computer device and/or system such as a computer system used by a bank or other savings or investment institution. The computer hardware system also may include a memory 42, e.g., a non-transitory memory, for containing program instructions, such as those described herein, for carrying out the method of the steps of the invention. The memory also may keep track of payment deposits as well as interest deposits to the respective savings accounts. A display and keyboard (or other input/output device(s)) 43 may be used as part of the computer hardware system 40 to display information to a user, e.g., to a customer to show current value of the savings account, to a customer or bank teller, etc., to facilitate making/entering a deposit, and so on. Other input/output (I/O) 44 may be provided with respect to the computer 41 for use in providing inputs and outputs with respect to the computer, e.g., transferring information from a remote source, such as a received electronic payment, confirming receipt of same, providing account balance information, and so on.

The computer hardware system 40 may include an input device 45, e.g., a keyboard to enter payments made to the savings account, to enter information for opening a savings account and for other input purposes, e.g., to enter interest rates paid to the account, and so on. The computer hardware system 40 also may include a loan providing output and a repayment of loan software module 46, for example, to keep track of loans made and repayments made according to the terms of the loan. The module 46 may be stored in memory 42 or may be stored in a separate memory or records.

The computer hardware system 40 may include logic, computer program code and the like, e.g., stored in memory 42, to carry out the several functions described above, e.g., with respect to the logic diagram 30 of FIG. 3 and other steps and procedures described herein. Another computer hardware system, e.g., a customer's personal computer or the like, may include logic, computer program code and the like, to carry out the steps described above, e.g., with respect to the logic diagram 20 of FIG. 2 and other steps and procedures described herein.

If/when it is time to receive the loan, the customer can decide if the customer would like to receive back his savings. However, keeping the college savings account open and linking it to use ACH transfers to pay for the loan will be required for a customer to keep the discounted rate. The customer's loan has an estimated four year deferment period, while the child is in school, where interest is capitalized onto the total amount of the loan. Customers are allowed to pay interest while the child is in school, and there is no loan pre-payment penalty.

Additional variations on the system and method include, for example, use of debt-income level or any other measure during a specified time period before a loan in order to determine credit. However, each method is not to be used in conjunction with credit score, but rather instead of credit score.

This product is beneficial to customers for many reasons. It offers customers a forced college savings tool along with a reward for their proven lower default rate risk. A customer could save upwards of $7,000 by using this product.

The reason that the product can offer a significantly lower interest rate than financial institutions is by pre-selecting borrowers who are less likely to default than the averages. Therefore, although the interest rate to be paid on loans in the future using the product may be 6.4%, the default risk may be on the order of 1%. This product pre-selects those persons/families that are financially responsible enough to re-pay a loan. Each customer will have already proven over 1-2 years that the customer can make monthly payments on a loan. If a customer struggles during this period to make payments, then the customer will be ineligible to receive the discounted interest rate. Struggle is defined as failure to make any monthly $300 or $500 deposit or having any monthly deposit total decreasing below $300 or $500 depending on the enrolled program.

### EXAMPLE 1

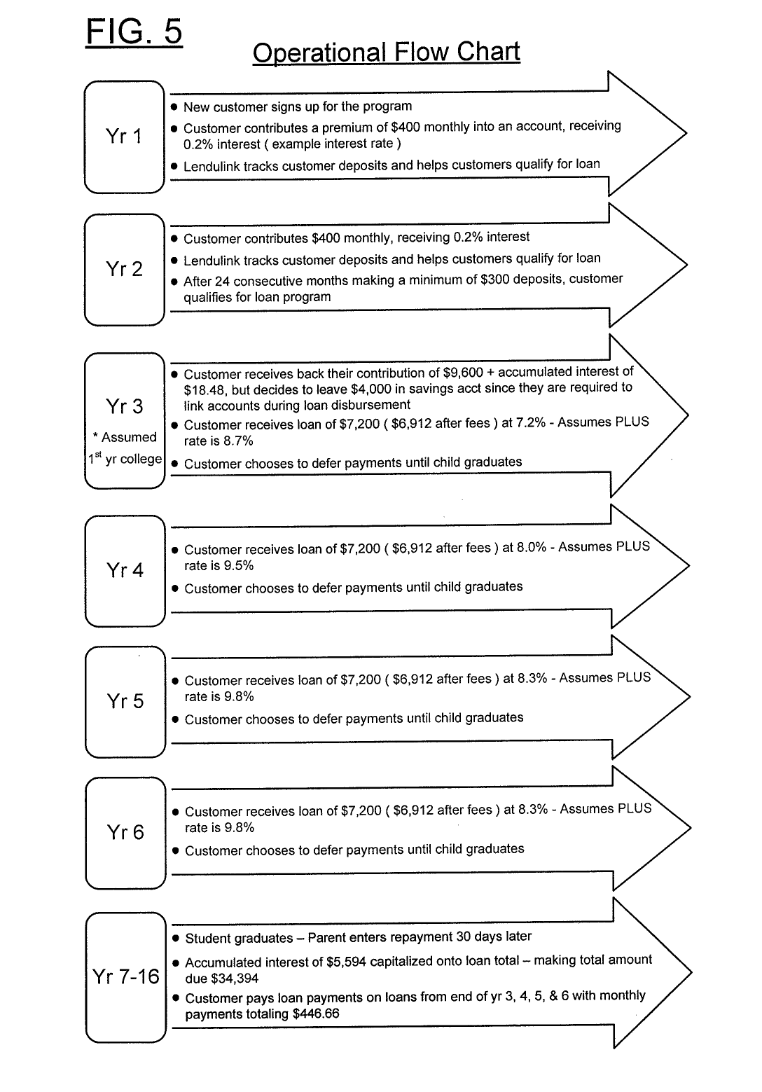

Reference is made to the attached operational flow chart of FIG. 5, as an example of the product and method described herein.

In the first year, “Yr 1”, a customer signs up for the program. The customer contributes a premium of $400 monthly, for example, into an account and receives 0.2% interest. The customer must maintain paying the monthly deposits for the full term, e.g., for each of the first through fourth years.

In the second year the customer also contributes $400 monthly to the customer's account. Interest for each of those years 1-2 is paid at 0.2% compounded monthly.

At the beginning of year, “Yr 3”, the customer receives back the customer's contributions, which should be $9,600 if fully paid in by the customer, plus accumulated interest of $18.42. This is the amount of interest on 24 $400 payments with a yearly interest rate of 0.2% and compounded monthly.

Then, at the beginning of the third year, the customer receives a loan of $7,200 at an interest rate of 6.4%. The customer was charged this amount because he signed up for ACH transfers from his savings account.

Year 3 is, for example, the first year of the customer's student, e.g., son or daughter, attends college. Thus, the loan received at the beginning of year 3 is for college costs. In each of years 4, 5 and 6 the customer also receives a loan of $7,200. The 10-Year Treasury note is projected to be at 5.2% when these loans are distributed. There is a deferment period while the child is in college where the customer chooses not to make interest payments on the loan. Therefore, year 7 is the first year where payments are made on the loan. After capitalizing the interest from the deferment period, the total amount due has increased to $34,776.

Additionally, in years 7-16 there are no further loans, but the customer pays the remaining loan balance with interest continuing to be paid at 8.3%. This situation also assumes that interest rates do not change between years 3-6. In most cases, loans for different years will carry different fixed interest rates due to interest rate movement. In this scenario, the customer's monthly payments total $458.16, since the customer has decided to repay the loan in 9 years. Because the customer had demonstrated in the first two years that the customer was able to make the required deposits on a regular basis, the company can have reasonable confidence that the customer would make the necessary loan repayments in a timely manner, i.e., risk of default would be minimal as compared to the current default rate mentioned above.

The numbers in the above example are only exemplary. The values represented by these numbers may be different, e.g., the contribution amount to the account of the customer, the various interest rates, and so on. These may be different depending on various factors, e.g., current bank interest charged and paid, other financial conditions, and so on.

Summarizing, a method of determining default risk without use of credit score and providing discounted loans includes, receiving from a customer payments put into an account of the customer of a predetermined amount paid periodically over a predetermined time frame, determining default risk based on such received amounts, determining whether the customer qualifies for a discounted loan rate, and providing the customer such loan at discounted rate if the customer qualifies. Apparatus for carrying out one or more of the foregoing steps.

The preferred embodiments of the present invention are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discreet logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present invention comprise other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present invention by using the apparatus.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A method of determining default risk without use of credit score, comprising,
a. Receiving from a customer payments put into an account of the customer of a predetermined amount paid periodically over a predetermined time frame,
c. Offering to the customer a loan to provide funds to the customer in a loan amount no greater than the approved Parent PLUS borrowing maximum as determined by individual universities through the formula of the total cost of college minus received federal aid with interest computed at a prescribed amount less than the interest rate for a Parent Plus loan, and repayment of the still owed loan amount plus interest being due and payable to company at a rate at least equal to the predetermined amount specified in step a,
d. At the conclusion of the predetermined time frame, returning the payments to the customer, and
e. If the customer accepts the loan offered at step c, also providing the customer the requested loan amount in step c.
